(19) United States
(12) Patent Application Publication
(10) Pub. No.: US 2015/0354031 A1
(43) Pub. Date: Dec. 10, 2015

(54) NICKEL-COBALT ALLOY

(71) Applicant: VDM METALS GMBH, Werdohl (DE)

(72) Inventors: Budo GEHRMANN, Plettenberg (DE); Jutta KLOEWER, Duesseldorf (DE); Tatiana FEDOROVA, Schwuelper (DE); Joachim ROESLER, Braunscheid (DE)

(73) Assignee: VDM Metals GmbH, Werdohl (DE)

(21) Appl. No.: 14/762,088

(22) PCT Filed: Feb. 13, 2014
(86) PCT No.: PCT/DE2014/000053

§ 371 Date: Jul. 20, 2015

(30) Foreign Application Priority Data
Feb. 14, 2013 (DE) 10 2013 002 483.8

(51) Int. Cl. C22C 19/05; B23K 35/30; C22C 30/00; C22F 1/10; C22F 1/00

(52) U.S. Cl. CPC C22C 19/056; C22F 1/10; C22F 1/00; C22C 30/00; B23K 35/304; B23K 35/3033

(57) ABSTRACT

A Ni—Co alloy includes 30 to 65 wt % Ni, >0 to max. 10 wt % Fe, >12 to <35 wt % Co, 13 to 23 wt % Cr, 1 to 6 wt % Mo, 4 to 6 wt % Nb+Ta, >0 to <3 wt % Al, >0 to <2 wt % Ti, >0 to max. 0.1 wt % C, >0 to max. 0.03 wt % P, >0 to max. 0.01 wt % Mg, >0 to max. 0.02 wt % B, >0 to max. 0.1 wt % Zr, which fulfils the following requirements and criteria: a) 900° C.<γ′ solvus temperature<1030° C. with 3 at %<Al+Ti (at %)<5.6 at % and 11.5 at %<Co<35 at %; b) stable microstructure after 500 h of ageing annealing at 800° C. with a ratio Al/Ti>5 (on the basis of the contents in at %).

The subject matter of the invention relates to a nickel-cobalt alloy.

An important metallic material for rotating disks in gas turbines is the nickel-base Alloy 718. The chemical composition of Alloy 718 is listed in Table 1 of the AMS 5662 standard.

The requirements applicable to the mechanical properties that Alloy 718 must have in accordance with the AMS 5662 standard are listed in Table 2. Furthermore, for use as a rotating disk in an aircraft turbine, an elongation of <0.2% is required after a creep test at a temperature of 650° C. and a load of 550 MPa after a loading time of 35 h (or after 100 h in the case of even more stringent requirements), while high cycle numbers to failure are expected in the low cycle fatigue/LCF test. Depending on test condition, cycle numbers of several 10,000 cycles up to cycles of more than 100,000 are required, as specified on the basis of different disk designs. In accordance with the AMS 5662 standard, the mechanical requirements must be satisfied after a three-stage annealing process—one hour of solution annealing at an annealing temperature between 940 and 1000° C.+precipitation hardening at 720° C. for 8 h+620° C. for 8 h.

Essentially two precipitation phases are responsible for the high strength properties of nickel-base Alloy 718. They are on the one hand the γ″-phase Ni₃Nb and on the other hand the γ′-phase Ni₃(Al, Ti). A third important precipitation phase is the δ-phase, which limits Alloy 718 to a maximum temperature of 650° C., since above that temperature the metastable γ″-phase is transformed to the stable δ-phase. As a consequence of this transformation, the material loses its creep-strength properties. In the course of the process of manufacture of Alloy 718 material from the remelted ingot to the semifinished form of a forged billet, however, the δ-phase plays an important role in achieving a very fine-grained homogeneous grain structure during the forging process. During forging heats in the range of the precipitation temperature of the δ-phase, small proportions at precipitates of δ-phase result in grain refinement. This fine grain of the billet microstructure is preserved or becomes even more fine-grained due to hot forming during the manufacture in particular of turbine disks, even though forging in this case takes place at a temperature below the δ-phase solution temperature. The very fine-grained microstructure is a prerequisite for very high cycle numbers to failure in the LCF test. Since the precipitation temperature of the γ′-phase of Alloy 718 is very much lower than the δ-phase solution temperature of approximately 1020° C., Alloy 718 has a broad window of forming temperature, and so forging from ingot to billet or from billet to turbine disk is unproblematic as regards possible surface disruptions due to γ′-phase precipitates, which may occur during forging at very low temperatures. Thus Alloy 718 is very amenable to the hot-forming process. Nevertheless, one disadvantage is the relatively low application temperature of Alloy 718, up to 650° C.

Another nickel alloy known as “Waspaloy” is characterized by good microstructural stability at higher temperatures, up to approximately 750° C., and so its application temperature is approximately 100 K higher than that of Alloy 718. Waspaloy achieves its microstructural stability up to higher temperatures by higher alloying proportions of the elements Al and Ti. Herewith Waspaloy exhibits a high solution temperature of the γ′-phase, which in turn permits a higher application temperature. The chemical composition of Waspaloy is listed in Table 3 in accordance with the AMS 5704 standard.

The requirements imposed on the mechanical properties that Waspaloy must achieve in accordance with the AMS 5704 standard are listed in Table 4. Furthermore, for use as a rotating disk in an aircraft turbine, an elongation of <0.2% is required after a creep test at a test temperature and a test load after a loading time of 35 h (or after 100 h in the case of even more stringent requirements), while high cycle numbers to failure are expected in the low cycle fatigue/LCF test. In this connection, depending on test condition, cycle numbers of several 10,000 cycles up to cycles of more than 100,000 are required, as specified on the basis of different disk designs. In accordance with the AMS 5704 standard, the mechanical requirements must be satisfied after a three-stage annealing process—four hours of solution annealing at an annealing temperature between 996 and 1038° C.+stabilization annealing at 845° C. for 4 h+precipitation hardening at 760° C. for 16 hours.

However, the high γ′ solution temperature of approximately 1035° C. is also the cause of the poor hot formability of Waspaloy. At a surface temperature of approximately 980° C., deep discontinuities caused by γ′-phase precipitates may develop at the surface of the forged pieces during processes of forging from the remelted ingot to billets or from the billet to turbine disks. Thus the window of forming temperature for Waspaloy is relatively small, necessitating several forming heats due to multiple exposures in heating furnaces, in turn resulting in a longer process duration and therefore higher manufacturing costs. Because of the necessarily higher forging temperatures and the absence of a grain-refining δ-phase, a very fine grain microstructure in the billet forged from Waspaloy is not achievable, in contrast to what can be illustrated for Alloy 718.

For aircraft applications, Alloy 718 and Waspaloy are smelted as the primary heat in a VIM furnace then cast as round electrodes in chill molds. After further processing steps, either the electrodes are remelted in the ESR or VAR double-melt smelting process or VAR resmelted ingots are produced in the VIM/ESR/VAR triple-melt process. Before the resmelted ingots can be hot-formed, they are subjected to homogenization annealing. Thereafter the resmelted ingots are forged in several forging heats to billets, which in turn are used as forging stock for the manufacture, for example, of turbine disks.

U.S. Pat. No. 6,730,264 discloses a nickel-chromium-cobalt alloy of the following composition: 12 to 20% Cr, up to 4% Mo, up to 6% W, 0.4 to 1.4% Ti, 0.6 to 2.6% Al, 4 to 8% Nb (Ta), 5 to 12% Co, up to 14% Fe, up to 0.1% C, 0.003 to 0.03% P, 0.003 to 0.015% B, the rest nickel.

DE 69934258 T2 discloses a process for manufacturing an object formed from Waspaloy, which process includes the following steps:
a) Preparing a batch of a material that consists, in wt %, of 18 to 21 Cr, 3.5 to 5 Mo, 12 to 15 Co, 2.75 to 3.25 Ti, 1.2 to 1.6 Al, up to 0.08 Zr, 0.003 to 0.010 B, the rest Ni and incidental impurities;
b) Smelting the batch of the material in a vacuum environment at a pressure of less than 100μ (13.33 Pa) in a ceramic-free smelting system and heating the batch of the material to a limited superheat step within 200° F. (93° C.) above the melting point of the alloy;
c) Pouring the smelted batch of the material into a shot cylinder of a pressure die-casting apparatus in the vacuum environment, so that the molten material fills less than half of the shot cylinder; and
d) Injecting the molten material under pressure into a reusable mold.

The invention is based on the object of providing an alloy in which the previously described advantages of the two known alloys, Alloy 718 and Waspaloy, i.e., the good hot formability of Alloy 718 and the microstructural stability of Waspaloy up to higher temperatures of approximately 750° C., can be combined.

This task is accomplished by an Ni—Co alloy with 30 to 65 wt % Ni, >0 to max. 10 wt % Fe, >12 to <35 wt % Co, 13 to 23 wt % Cr, 1 to 6 wt % Mo, 4 to 6 wt % Nb+Ta, >0 to <3 wt % Al, >0 to <2 wt % Ti, >0 to max. 0.1 wt % C, >0 to max. 0.03 wt % P, >0 to max. 0.01% wt Mg, >0 to max. 0.02% wt B, >0 to max. 0.1% wt Zr, which alloy satisfies the requirements and criteria listed below:
a) 900° C.≦γ′-solvus temperature≦1030° C. at 3 at %≦Al+Ti (at %)≦5.6 at % as well as 11.5 at %≦Co≦35 at %;
b) stable microstructure after 500 h of aging annealing at 800° C. and an Al/Ti ratio≧5 (on the basis of the contents in at %).

Advantageous improvements of the inventive alloy are specified in the associated dependent claims.

On the basis of the parameters mentioned in claim 1, the inventive alloy no longer exhibits the disadvantages of Alloy 718, namely the relatively low application temperature, and of Waspaloy, namely the poor hot formability.

The inventive alloy preferably satisfies the requirement “945° C.≦γ′-solvus temperature 1000° C.”.

It is of particular advantage when Co contents between 11.5 and 35 at % can be adjusted at a ΔT (δ−γ′)≧80 K and Al+Ti≦4.7 atomic %.

The inventive alloy advantageously has a temperature interval between δ-solvus and γ′-solvus temperatures equal to or greater than 140 K and at the same time a Co content between 15 and 35 at %.

According to a further improvement of the invention, the Ti content in the alloy is adjusted to ≦0.8 atomic % and more preferably to a content of ≦0.65 atomic %.

Restricting the (Nb+Ta) contents to values between 4.7 and 5.7 wt % may also contribute to improving the good hot deformability of Alloy 718 and the microstructural stability of Waspaloy up to higher temperatures of approximately 750° C.

The value ranges for a ratio of two element contents are different when expressed in atomic and weight percent. At the structural level, atomic proportions are essential. The contents of the elements essential for the inventive alloy, namely Al, Ti and Co, are presented in atomic % especially in Table 6a.

The inventive alloy may also contain the following elements as residual elements:

### Cu max. 0.5 wt %

### S max. 0.015 wt %

### Mn max. 1.0 wt %

### Si max. 1.0 wt %

### Ca max. 0.01 wt %

### N max. 0.03 wt %

### O max. 0.02 wt %

If appropriate for the respective application, the inventive alloy may if necessary also contain the following elements

### V up to 4 wt %

### W up to 4 wt %

In the inventive alloy, the elements listed below may be adjusted as follows:

### 0.05 at %≦Ti≦0.5 at %,

### 3.6 at %≦Al≦4.6 at %,

### 15 at %≦Co≦32 at %.

Depending on area of application of the inventive alloy, it may be appropriate from cost viewpoints to substitute part of the elements Ni and/or Co with the less expensive element Fe.

The inventive alloy is preferably usable as a component in an aircraft turbine, especially a rotating turbine disk, as well as a component of a stationary turbine.

The alloy may be produced in the following semifinished forms: strip, sheet, wire, bar.

The material is creep-resistant at high temperature and, besides the already mentioned applications, can also be used for the following service areas: in engine construction, in exhaust-gas systems, as heat shields, in furnace construction, in boiler construction, in power-plant construction, especially as superheater pipes, as structural parts in gas and oil extraction engineering, in stationary gas and steam turbines and also as a weld filler for all of the said applications.

The present invention describes a nickel alloy, especially for critical rotating components of an aircraft turbine. The inventive alloy has a high microstructural stability at high temperatures and therefore offers the possibility of application at thermal loads up to 100 K hotter than for the known nickel-base Alloy 718. Furthermore, the inventive alloy is characterized by better formability than the nickel alloy known as Waspaloy. The alloy of the present invention offers technological properties that permit applications in gas turbines in the form of disks, blades, holders, housings or shafts.

The present alloy describes the chemical composition, the technological properties and the processes for the manufacture of semifinished products made from the material of the inventive nickel-cobalt alloy.

The properties of the inventive alloy are discussed hereinafter:

Numerous laboratory heats with different chemical compositions were produced by means of a laboratory vacuum arc furnace.

Each heat was cast into a heavy-duty cylindrical copper chill mold with a diameter of 13 mm. During smelting, three bars with a length of approximately 80 mm were produced. All alloys were homogenized after smelting. The entire process took place in the vacuum furnace and consisted of 2 stages: 1140° C./6 h+1175° C./20 h. This was followed by quenching in an argon atmosphere. Hot forming for the smelted alloys was carried out using a rotary swaging machine. The bars had a diameter of 13 mm at the beginning and were reduced in diameter by four rotary swaging operations of one millimeter each to obtain the final diameter of 9 mm.

Table 1 discloses the chemical composition of Alloy 718 corresponding to the prior art as specified by the valid AMS 5662 standard, while Table 2 presents the mechanical properties of that alloy.

Table 3 discloses the chemical composition of Waspaloy corresponding to the prior art as specified by the valid AMS 5662 standard, while Table 4 presents the mechanical properties of that alloy.

The inventive chemical compositions of the laboratory heats are listed in Table 5. At the bottom, the known alloys A718, A718 Plus and Waspaloy are also included as reference materials. In addition to the reference materials, the test alloys are identified with the letters V and L plus 2 numerals each. The chemical compositions of these test alloys include variations in the contents of the elements Ti, Al, Co and Nb.

When the contents of the elements Ti, Al and Co as well as the sum of Al+Ti and the Al/Ti ratio of the contents of the elements are expressed in atomic percent, very good technological properties are obtained in selected ranges for the γ′-solvus temperature, the difference between δ-solvus and γ′-solvus temperatures, the absence of primary delta phase and absence of the η-phase, the microstructural stability at 800° C. after aging annealing tests for 500 h and the mechanical hardness HV after a standard heat treatment comprising solution annealing and two-stage precipitation-hardening annealing for A718 (980° C./1 h+720° C./8 h+620° C./8 h, see the AMS 5662 standard).

Table 6a lists the contents in atomic percent of the elements Al, Ti and Co as well as the sum of the Al+Ti contents (in atomic percent) and the Al/Ti ratios for the test alloys and the 3 reference materials of Table 5.

Furthermore, Table 6b contains the calculated solvus temperatures of the δ-phase and of the γ′-phase as well as the temperature difference ΔT (δ−γ′) calculated therefrom between the δ-solvus and γ′-solvus temperatures. Table 6b also indicates the mechanical hardness values 10 HV determined for the test alloys (after three-stage precipitation-hardening heat treatment of 980° C./1 h+720° C./8 h+620° C./8 h in accordance with the AMS 5662 standard for A718). Moreover, Table 6b indicates remarks on the occurrence of the η-phase (calculated or observed).

The criteria for selection of the inventive alloy are explained and exemplary test alloys are indicated in the following descriptions.

For reasons of strength and microstructural stability, the γ′-solvus temperature of the inventive alloy should be 50 K higher than that of alloy A718, which has a γ′-solvus temperature of approximately 850° C. On the other hand, the γ′-solvus temperature of the inventive alloy should be lower than or equal to 1030° C. This 1030° C. corresponds approximately to the γ′-solvus temperature of Waspaloy. A higher γ′-solvus temperature would influence the hot formability very negatively since, in the forging process, for example, γ′-precipitates already lead to extensive precipitation hardening of the surface of the forged piece if the surface temperatures of the forged piece are slightly below the γ′-solvus temperature, and this in turn may lead to considerable disruptions of the surface of the forged piece during further forming by forging.

Thus the requirement 900° C.≦γ′-solvus T≦1030° C. should be satisfied.

In FIG. 1, the γ′-solvus temperature of the test alloys is plotted against the sum of the Al+Ti contents (at %) of their chemical compositions.

From FIG. 1 it is evident that the requirement “900° C.≦γ′-solvus T≦1030° C.” is satisfied by the restriction 3 at %≦Al+Ti (at %)≦5.6 at %. The test alloys V12, V13, V14, V15, V16, V17, V20, V21, V22, L04, L07, L09, L15, L16, L17 and L18 are exemplary alloys for this range.

For even better hot formability, the γ′-solvus temperature of the inventive alloy should be <1000° C., and for microstructural stability at even higher temperature it should be >945° C. The test alloys V14, V16, V17, V20, V21, V22 L04, L15, L16, L17 and L18 are exemplary alloys for this range. The temperature range bounded between 945° C. and 1000° C. is evident from FIG. 2.

The Co content of the test alloys influences the δ-solvus and γ′-solvus temperatures and thus ΔT (δ−γ′). The Co content of the inventive alloy is not permitted to be too high, to ensure that no primary δ-phase develops. This restricts the Co content to <35 at %. Exemplary alloys in which primary δ-phase develops are the test alloys L12 and L13, both of which have a Co content of approximately 50 at %.

FIG. 3, in which the occurrence of the η-phase is marked on the plots of the Co and Ti contents of the test alloys, shows that the Ti content of the inventive alloy must be limited to ≦0.8 at % in alloys with Co contents greater than 16 at %, in order to prevent the development of a stable η-phase. Exemplary alloys with Ti 0.8 at % are the test alloys V12, V13, V14, V15, V16, V17, V21 and V22. Preferred alloys have a Ti content of 0.65 at %. These are the exemplary test alloys V16, V17, V21 and V22.

During the forging process, minor proportions of δ-phase are consumed for grain refining of the microstructure. In other words, forging in the last forging heats is carried out starting from a temperature slightly below the δ-solvus temperature, in order to produce a very fine-grained microstructure of the respective forged piece. On the other hand, in order to make it possible to work with a sufficiently broad window of forging temperatures, the γ′-solvus temperature cannot be permitted to be too high, and it must lie well below the δ-solvus temperature of the inventive alloys. For the window of forging temperature to be sufficiently broad, it must be ≧80 K. Therefore the difference ΔT (δ−γ′) between δ-solvus temperature and γ′-solvus temperature must be ≧80 K.

From FIG. 4, it can be seen that ΔT (δ−γ′) is 80 K when the sum of the Al+Ti contents is 4.7 at % and the Co content is ≧11.5 at %. Even greater temperature intervals of ≧140 K between δ-solvus temperature and γ′-solvus temperature are possible if at the same time the Co content of the alloy is ≧15 at %.

A further criterion results from the requirement that states that the microstructure of the inventive alloy should be stable at an aging temperature of 800° C. (after 500 h). This criterion is satisfied by the inventive alloys that have an Al/Ti ratio of ≧5.0. Exemplary alloys for this condition are the test alloys V13, V15, V16, V17, V21 and V22.

Table 7 lists exemplary test alloys for the requirement of the Al/Ti ratio of the inventive alloy.

FIGS. 5a to 5e show exemplary SEM photographs for the test alloys L4, V10, V15, V16 and V17 after aging annealing for 500 h at 800° C.

TABLE 1
Chemical composition of Alloy 718 in
accordance with the AMS 5662 standard

| Element | Weight percent |
|---|---|
| C | max. 0.08 |
| Mn | max. 0.35 |
| P | max. 0.015 |
| S | max. 0.015 |
| Si | max. 0.35 |
| Cr | 17-21% |
| Ni | 50-55% |
| Fe | Rest |
| Mo | 2.8-3.3% |
| Nb | 4.75-5.5% |
| Ti | 0.65-1.15% |
| Al | 0.2-0.8% |
| Al + Ti | 0.85-1.95% |
| Co | max. 1% |
| B | max. 0.006% |
| Cu | max. 0.3% |
| Pb | max. 0.0005% |
| Se | max. 0.0003% |
| Bi | max. 0.00003% |

TABLE 2
Mechanical properties of Alloy 718 in
accordance with the AMS 5662 standard

| | | Requirements | |
|---|---|---|---|
| | | in accordance | |
| Mechanical properties | Test conditions | with AMS 5662 | |
| Offset yield strength Rp0.2 | 20° C. | ≧1034 | MPa |
| Tensile strength Rm | 20° C. | ≧1276 | MPa |
| Elongation A5 | 20° C. | ≧12% | |
| Hardness HB | 20° C. | ≧331 | HB |
| Offset yield strength Rp0.2 | 650° C. | ≧862 | MPa |
| Tensile strength Rm | 650° C. | ≧1000 | MPa |
| Elongation A5 | 650° C. | ≧12% | |
| Reduction of area at break Z | 650° C. | ≧15% | |
| Stress rupture test | | | |
| Time to break | 650° C. | ≧23 | h |

| | | |
|---|---|---|
| Elongation A5 | Load 725 MPa | ≧4% |

TABLE 3
Chemical composition of Waspaloy in
accordance with the AMS 5704 standard

| Element | Weight percent |
|---|---|
| C | 0.02-0.10% |
| Mn | max. 0.1% |
| P | max. 0.015% |
| S | max. 0.015% |
| Si | max. 0.15% |
| Cr | 18-21% |
| Fe | max. 2% |
| Mo | 3.5-5.0% |
| Nb | |
| Ti | 2.75-3.25% |
| Al | 1.2-1.6% |
| Co | 12-15% |
| Ni | Rest |
| B | 0.003-0.01% |
| Cu | max. 0.1% |
| Zr | 0.02-0.08% |
| Pb | max. 0.0005% |
| Bi | max. 0.00003% |
| Se | max. 0.0003% |
| Ag | max. 0.0005% |

TABLE 4
Mechanical properties of Waspaloy in
accordance with the AMS 5704 standard

| | | Requirements | |
|---|---|---|---|
| | | in accordance | |
| Mechanical properties | Test conditions | with AMS 5662 | |
| Offset yield strength Rp0.2 | 20° C. | ≧827 | MPa |
| Tensile strength Rm | 20° C. | ≧1207 | MPa |
| Elongation A5 | 20° C. | ≧15% | |
| Hardness HB | 20° C. | ≧341 HB and | |
| | | ≧401 HB | |
| Offset yield strength Rp0.2 | 538° C. | ≧724 | MPa |
| Tensile strength Rm | 538° C. | ≧1069 | MPa |
| Elongation A5 | 538° C. | ≧15% | |
| Reduction of area at break Z | 538° C. | ≧18% | |
| Stress rupture test | | | |
| Time to break | 732° C. | ≧23 | h |
| Elongation A5 | Load 552 MPa | ≧5% | |
| Stress rupture test | | | |
| Time to break | 816° C. | ≧23 | h |

| | | |
|---|---|---|
| Elongation A5 | Load 293 MPa | ≧5% |

TABLE 5
Chemical compositions (in weight percent) of the
test alloys (actual analysis). The C content of all
alloys is approximately 0.025 wt %. If necessary, the
respective alloy may contain the following elements
as residual elements: Cu, S, Mn, Si, Ca, N, O.
Depending on application, W up to 4 wt % and/or V up
to 4 wt % may also be present in the respective alloy.
The alloys A718Plus and Waspaloy respectively contain
1 wt % W.

| Alloy | Ni | Fe | Cr | Mo | Ti | Al | Nb + Ta | Co |
|---|---|---|---|---|---|---|---|---|
| V05 | Rest | 0.05 | 18.17 | 2.96 | 2.00 | 1.96 | 5.50 | 17.03 |
| V07 | Rest | 0.06 | 18.40 | 2.96 | 2.01 | 1.97 | 5.45 | 29.95 |
| V10 | Rest | 0.05 | 18.48 | 3.03 | 1.11 | 2.04 | 5.38 | 17.03 |
| V11 | Rest | 0.06 | 18.50 | 3.05 | 1.11 | 2.03 | 5.39 | 30.04 |
| V12 | Rest | 0.05 | 18.40 | 2.97 | 0.50 | 1.23 | 5.53 | 17.04 |
| V13 | Rest | 0.04 | 18.41 | 2.99 | 0.49 | 1.97 | 5.50 | 16.98 |
| V14 | Rest | 0.04 | 18.43 | 2.99 | 0.49 | 1.60 | 5.52 | 17.01 |
| V15 | Rest | 0.04 | 18.50 | 2.96 | 0.50 | 2.33 | 5.45 | 17.05 |
| V16 | Rest | 0.05 | 18.25 | 2.98 | 0.17 | 1.90 | 5.51 | 17.25 |
| V17 | Rest | 0.05 | 18.48 | 2.96 | 0.17 | 1.90 | 5.40 | 24.98 |
| V20 | Rest | 0.05 | 18.70 | 2.99 | 0.52 | 2.04 | 5.60 | 30.10 |
| V21 | Rest | 0.04 | 18.70 | 2.96 | 0.20 | 2.04 | 5.58 | 25.06 |
| V22 | Rest | 0.04 | 18.70 | 2.96 | 0.20 | 2.04 | 5.40 | 30.10 |
| L03 | Rest | 0.18 | 18.20 | 2.90 | 0.75 | 0.63 | 5.49 | 16.98 |
| L04 | Rest | 0.04 | 18.45 | 3.06 | 1.09 | 1.24 | 5.46 | 17.05 |
| L06 | Rest | 0.21 | 18.40 | 2.91 | 0.73 | 0.64 | 5.49 | 30.00 |
| L07 | Rest | 0.38 | 18.32 | 2.93 | 1.07 | 0.92 | 5.49 | 17.04 |
| L09 | Rest | 0.46 | 18.40 | 2.94 | 1.46 | 1.23 | 5.60 | 16.90 |
| L12 | Rest | 0.34 | 18.50 | 2.90 | 0.72 | 0.61 | 5.36 | 49.76 |
| L13 | Rest | 0.45 | 18.32 | 2.90 | 1.48 | 0.69 | 5.59 | 49.88 |
| L15 | Rest | 0.03 | 18.47 | 3.03 | 1.09 | 1.25 | 5.38 | 13.99 |
| L16 | Rest | 0.03 | 18.46 | 3.02 | 1.64 | 0.92 | 5.40 | 12.00 |
| L17 | Rest | 0.04 | 18.42 | 3.04 | 1.12 | 1.23 | 5.41 | 25.14 |
| L18 | Rest | 0.05 | 18.49 | 3.04 | 1.11 | 1.24 | 5.38 | 30.01 |
| A718 | Rest | 17.06 | 18.71 | 2.93 | 0.99 | 0.48 | 5.32 | 0.02 |
| A718Plus | Rest | 10.00 | 18.00 | 2.75 | 0.70 | 1.45 | 5.45 | 9.00 |
| Waspaloy | Rest | 0.20 | 19.5 | 4.25 | 3.00 | 1.30 | 0 | 13.5 |

TABLE 6a
Element contents in atomic percent or ratios
of element contents of the test alloys

| Alloy | | | | | |
|---|---|---|---|---|---|
| at % | Al/Ti | Al + Ti | Ti | Al | Co |
| V05 | 1.74 | 6.58 | 2.40 | 4.18 | 16.65 |
| V07 | 1.73 | 6.62 | 2.42 | 4.20 | 29.27 |
| V10 | 3.28 | 5.69 | 1.33 | 4.36 | 16.65 |
| V11 | 3.24 | 5.68 | 1.34 | 4.34 | 29.40 |
| V12 | 4.36 | 3.27 | 0.61 | 2.66 | 16.85 |
| V13 | 7.15 | 4.81 | 0.59 | 4.22 | 16.65 |
| V14 | 5.83 | 4.03 | 0.59 | 3.44 | 16.75 |
| V15 | 8.28 | 5.57 | 0.60 | 4.97 | 16.64 |
| V16 | 20.35 | 4.27 | 0.20 | 4.07 | 16.94 |
| V17 | 20.35 | 4.27 | 0.20 | 4.07 | 24.52 |
| V20 | 20.00 | 4.64 | 0.62 | 4.02 | 29.58 |
| V21 | 18.10 | 4.61 | 0.24 | 4.37 | 24.49 |
| V22 | 18.17 | 4.60 | 0.24 | 4.36 | 29.48 |
| L03 | 1.49 | 2.29 | 0.92 | 1.37 | 16.94 |
| L04 | 2.02 | 3.99 | 1.32 | 2.67 | 16.83 |
| L06 | 1.55 | 2.30 | 0.90 | 1.40 | 29.93 |
| L07 | 1.53 | 3.31 | 1.31 | 2.00 | 16.96 |
| L09 | 1.49 | 4.44 | 1.78 | 2.66 | 16.75 |
| L12 | 1.51 | 2.21 | 0.88 | 1.33 | 49.73 |
| L13 | 0.83 | 3.33 | 1.82 | 1.51 | 49.83 |
| L15 | 2.04 | 4.01 | 1.32 | 2.69 | 13.80 |
| L16 | 0.99 | 3.99 | 2.00 | 1.99 | 11.87 |
| L17 | 1.95 | 4.01 | 1.36 | 2.65 | 24.83 |
| L18 | 1.98 | 4.02 | 1.35 | 2.67 | 29.63 |
| A718 | 0.86 | 2.55 | 1.37 | 1.18 | 0.02 |
| A718Plus | 3.66 | 4.43 | 0.95 | 3.48 | 9.00 |
| Waspaloy | 0.77 | 6.3 | 3.56 | 2.74 | 13.5 |

TABLE 6b
Solvus temperatures of the δ-phase and of the γ′-phase,
difference ΔT (δ − γ′) of the solvus temperatures
of the δ- and γ′-phases, hardness 10 HV (after precipitation-
hardening heat treatment 980° C./1 h + 720° C./8 h +
620° C./8 h in accordance with the AMS 5662 standard for
A718) and remarks on the η-phase for the test alloys.

| | | | | | Remarks on the |
|---|---|---|---|---|---|
| | | | ΔT | | η-phase |
| | δ-solv. | γ′-solv. | (δ − γ′) | Hardness | (calculated or |
| Alloy | T (° C.) | T (° C.) | (K) | 10 HV | observed) |
| V05 | 1080 | 1077 | 3 | 506 | Large amounts |
| | | | | | of η-phase |
| V07 | 1157 | 1037 | 120 | 539 | η-Phase |
| V10 | 1090 | 1050 | 40 | 491 | No η-phase |
| V11 | 1180 | 1037 | 143 | 486 | η-Phase stable |
| | | | | | from 1127° C. |
| V12 | 1097 | 917 | 180 | 415 | No η-phase |
| V13 | 1087 | 1027 | 60 | 426 | No η-phase |
| V14 | 1097 | 967 | 130 | 417 | No η-phase |
| V15 | 1077 | 1027 | 50 | 470 | No η-phase |
| V16 | 1097 | 997 | 100 | 442 | No η-phase |
| V17 | 1152 | 957 | 195 | 448 | No η-phase |
| V20 | 1162 | 950 | 212 | 446 | Small amounts |
| | | | | | of η-phase; if |
| | | | | | necessary after |
| | | | | | aging at 800° C. |
| V21 | 1127 | 952 | 175 | 455 | No η-phase |
| V22 | 1177 | 952 | 225 | | No η-phase |
| L03 | 1117 | 887 | 230 | 396 | η-Phase stable |
| | | | | | from 937° C. |
| L04 | 1100 | 977 | 123 | 410 | Small amounts |
| | | | | | of η-phase, |
| | | | | | stable from |
| | | | | | 950° C. to 910° C. |
| L06 | 1200 | 700 | 500 | 473 | η-Phase stable |
| | | | | | from 1050° C. |
| L07 | 1100 | 900 | 200 | 442 | η-Phase stable |
| | | | | | from 1050° C. |
| L09 | 1100 | 950 | 150 | 488 | η-Phase more |
| | | | | | stable than δ |
| L12 | 1250 | none | | 530 | η-Phase |
| | | | | | primary, δ-phase |
| | | | | | primary, Laves |
| | | | | | phase |
| L13 | 1240 | none | | 503 | η-Phase |
| | | | | | primary, δ-phase |
| | | | | | primary, Laves |
| | | | | | phase |
| L15 | 1077 | 977 | 100 | 423 | η-Phase stable |
| L16 | 1070 | 977 | 93 | 450 | η-Phase stable |
| L17 | 1152 | 952 | 200 | 464 | η-Phase stable |
| | | | | | from 1097° C. |
| L18 | 1157 | 977 | 180 | 452 | η-Phase stable |
| | | | | | from 1047° C. |
| A718 | 1027 | 847 | 180 | 441 | No η-phase |
| A718Plus | 1027 | 976 | 51 | | η-Phase |
| | | | | | Nb₃Al_{0.5}Nb_{0.5} |
| Waspaloy | | 1035 | | | No η-phase, no |
| | | | | | γ″-phase |

TABLE 7
Exemplary test alloys for the requirement
of the Al/Ti ratios for inventive alloys.

| | | Microstructural | |
|---|---|---|---|
| | | stability after | |
| Alloy | Al/Ti | 500 h at 800° C. | Notes |
| L04 | 2.02 | Not satisfied | Exemplary alloy that does |
| | | | not satisfy the |
| | | | requirement |
| V13 | 7.15 | Satisfied | Exemplary alloy that |
| V15 | 8.28 | | satisfies the |
| | | | requirement, but at a |
| | | | relatively high γ′-solvus |
| | | | temperature |
| V16 | 20.35 | Satisfied | Exemplary alloys that |
| V17 | 20.35 | Satisfied | satisfy the requirement |

TABLE 8
Mechanical test values for A780 in comparison with A718
tested on upsetting-test specimens (solution-annealed + precipitation-hardened)

| | Tension test at | | | | Hot tension test at | | | |
|---|---|---|---|---|---|---|---|---|
| | 20° C. | | | | 650° C. | | | |
| | 20° C. | 20° C. | 20° C. | 20° C. | 650° C. | 650° C. | 650° C. | 650° C. |
| | Rp0.2 | Rm | A5 | Z | Rp0.2 | Rm | A5 | Z |
| Batch | (MPa) | (MPa) | (%) | (%) | (MPa) | (MPa) | (%) | (%) |
| 25 | 1179 | 1495 | 24 | 32 | 1046 | 1388 | 12 | 15 |
| 26 | 1191 | 1521 | 26 | 37 | 1015 | 1292 | 12 | 17 |
| 27 | 1222 | 1556 | 23 | 38 | 1055 | 1363 | 11 | 14 |
| A718 | 1262 | 1494 | 16 | 29 | 1031 | 1231 | 23 | 59 |
| (420159) | | | | | | | | |
| | Hot tension test at | | | | Hot tension test at | | | |
| | 700° C. | | | | 750° C. | | | |
| | 700° C. | 700° C. | 700° C. | 700° C. | 750° C. | 750° C. | 750° C. | 750° C. |
| | Rp0.2 | Rm | A5 | Z | Rp0.2 | Rm | A5 | Z |
| Batch | (MPa) | (MPa) | (%) | (%) | (MPa) | (MPa) | (%) | (%) |
| 25 | 1000 | 1245 | 11 | 13 | 908 | 1075 | 15 | 13 |
| 26 | 984 | 1203 | 10 | 10 | 910 | 1057 | 6 | 8 |
| 27 | 1032 | 1255 | 8 | 9 | 943 | 1109 | 11 | 12 |
| A718 | 958 | 1100 | 25 | 72 | 729 | 865 | 34 | 87 |
| (420159) | | | | | | | | |

By way of further description of the subject matter of the invention, FIGS. 6 and 7 are considered in conjunction with Table 8.

FIGS. 6 and 7 show diagrams containing data on strength tests at 20° C., 650° C., 700° C. and 750° C. on the new alloy (VDM Alloy 780 Premium), in this case batches 25, 26 and 27, in comparison with Alloy 718 (batch 420159) belonging to the prior art. From the diagrams it is evident that A 780, even when subjected to higher test parameters in hot tension tests, achieves higher Rp 0.2 strength values (measured on upsetting-test specimens in the precipitation-hardened condition) than A 718.

Furthermore, it was observed that, in the creep and stress rupture test at 700° C., A 780 also achieves the desired mechanical properties of creep elongation much smaller than 0.2% as well as much longer times to failure of >23 h in the stress rupture test—under otherwise identical test conditions where these properties are achieved by A 718 only at test temperatures up to 650° C.

Table 8 shows the batches 25 to 27 indicated in FIGS. 6 and 7 in comparison with A 718. Here it is evident that especially the tensile strength Rm of A 780 batches 25 to 27 achieves higher values than A 718 at higher temperatures (700° C. and 750° C.) in the hot tension tests.

### DESCRIPTION OF THE FIGURES

FIG. 1: γ′-Solvus temperatures of the test alloys versus the sum of the Al+Ti contents (atomic %) of the chemical compositions.

FIG. 2: γ′-Solvus temperatures of the test alloys versus the sum of the Al+Ti contents (at %) of the chemical compositions with the restricted temperature range between 945° C. and 1000° C.

FIG. 3: Occurrence of the η-phase versus the plots of the contents of Co and Ti of the test alloys.

FIG. 4: Difference between δ-solvus and γ′-solvus temperature of the test alloys versus the sum of the Al+Ti contents (at %). Open squares: Co<11.5 at %, open diamonds: 11.5 at %≦Co≦18 at %, closed diamonds: Co>18 at %.

FIG. 5: Exemplary SEM photographs for test alloys L4, V10, V15, V16 and V17 after aging annealing for 500 h at 800° C.

FIG. 6: A 780 variants in comparison with Alloy 718 (tension test: Rp 0.2)

FIG. 7: A 780 variants in comparison with Alloy 718 (tension test: Rm)

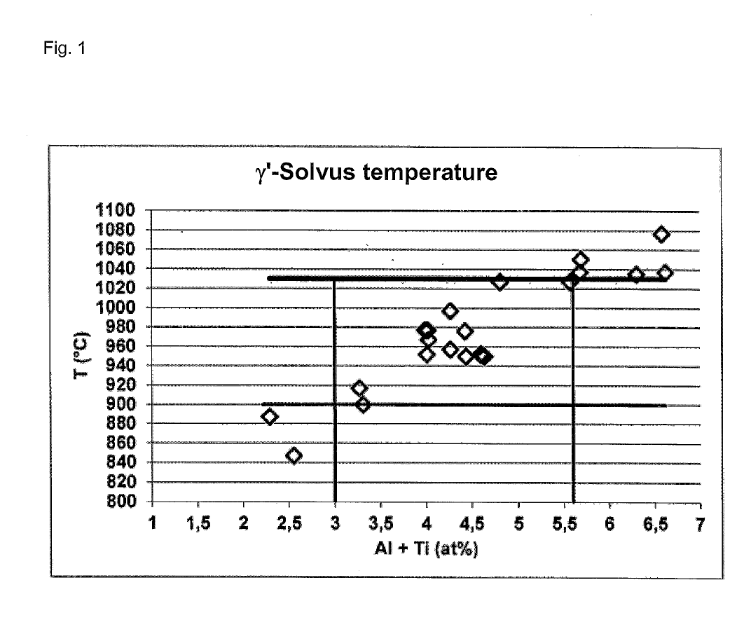

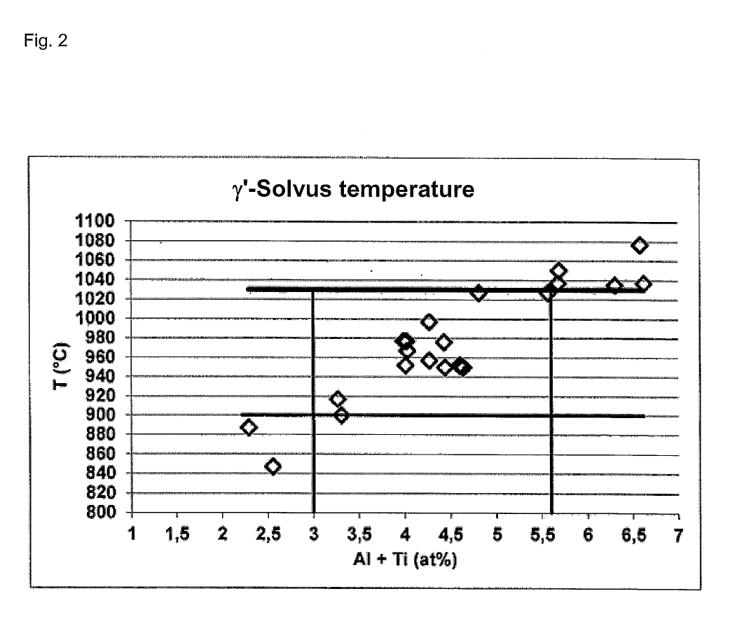

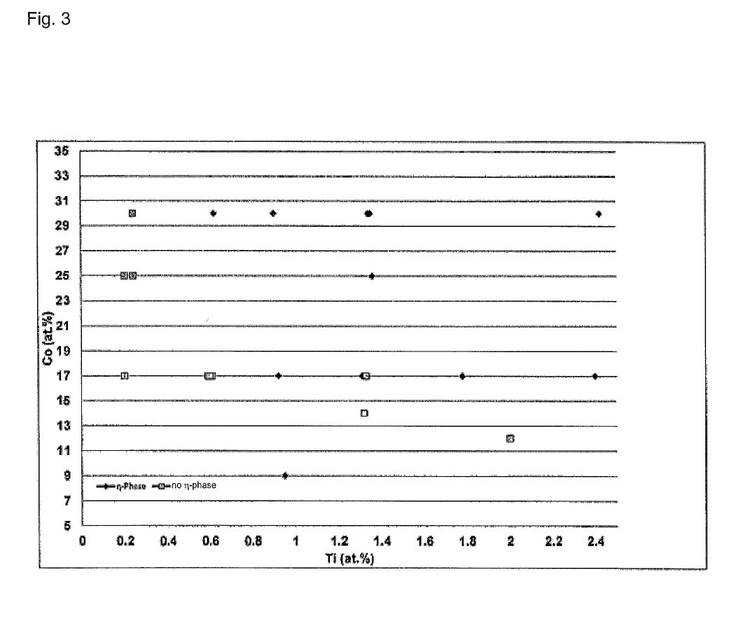

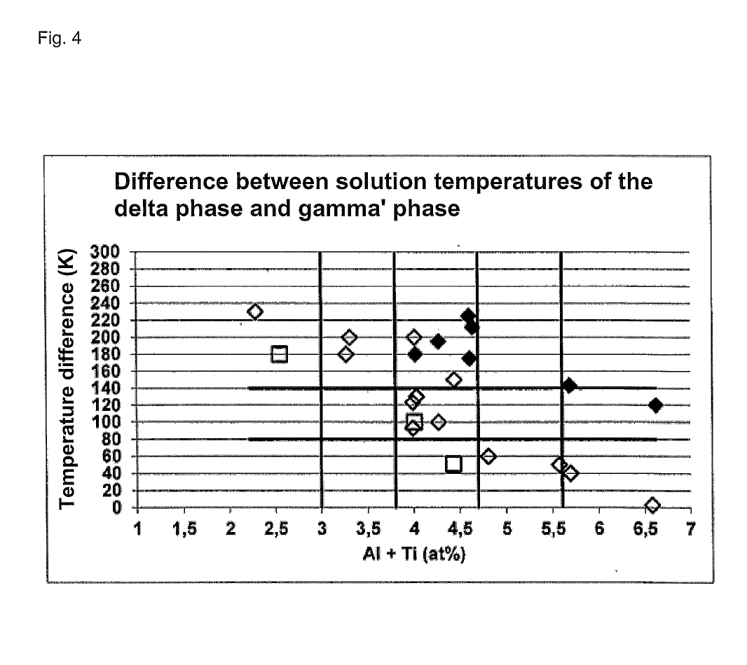

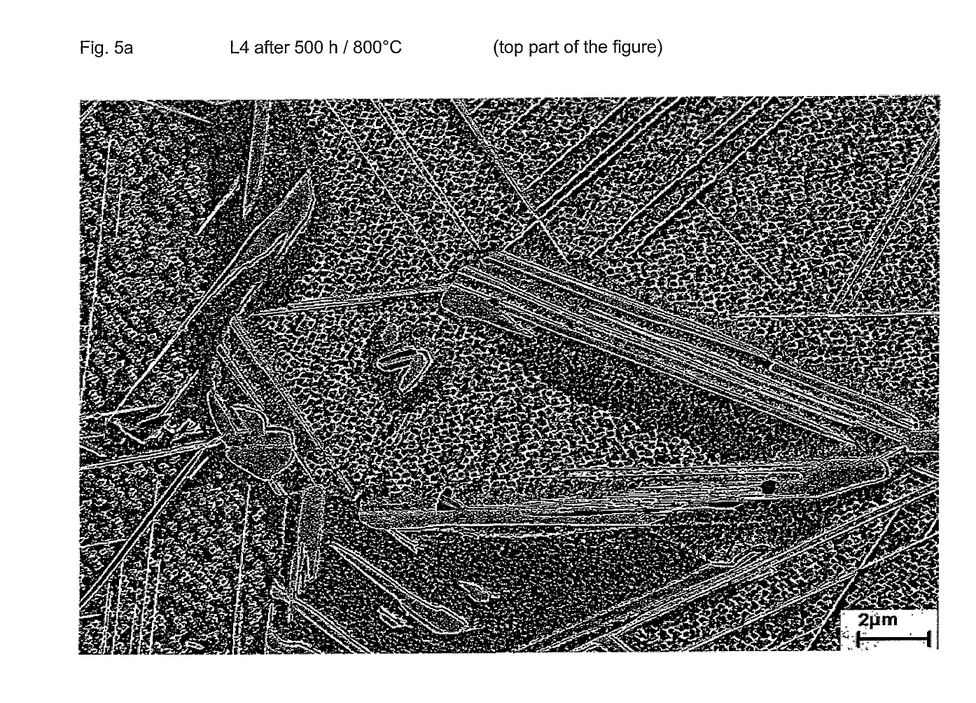

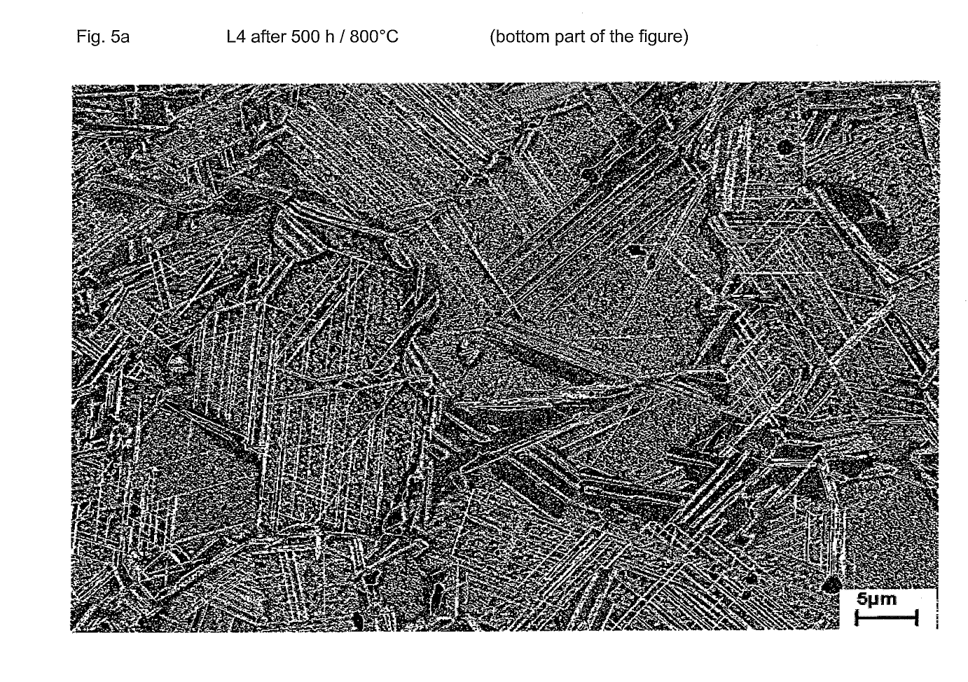

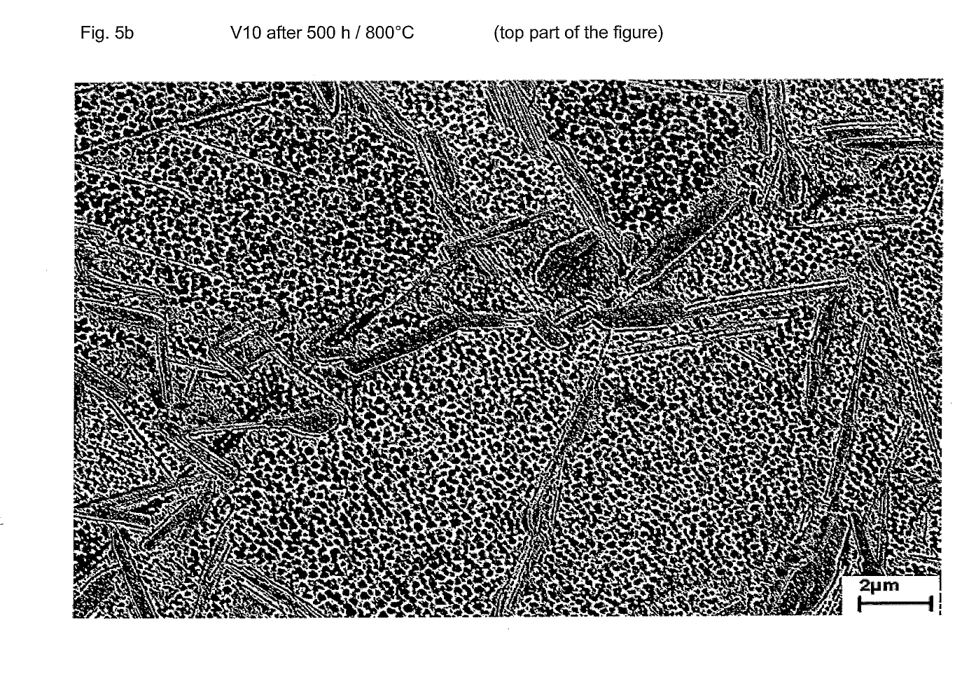

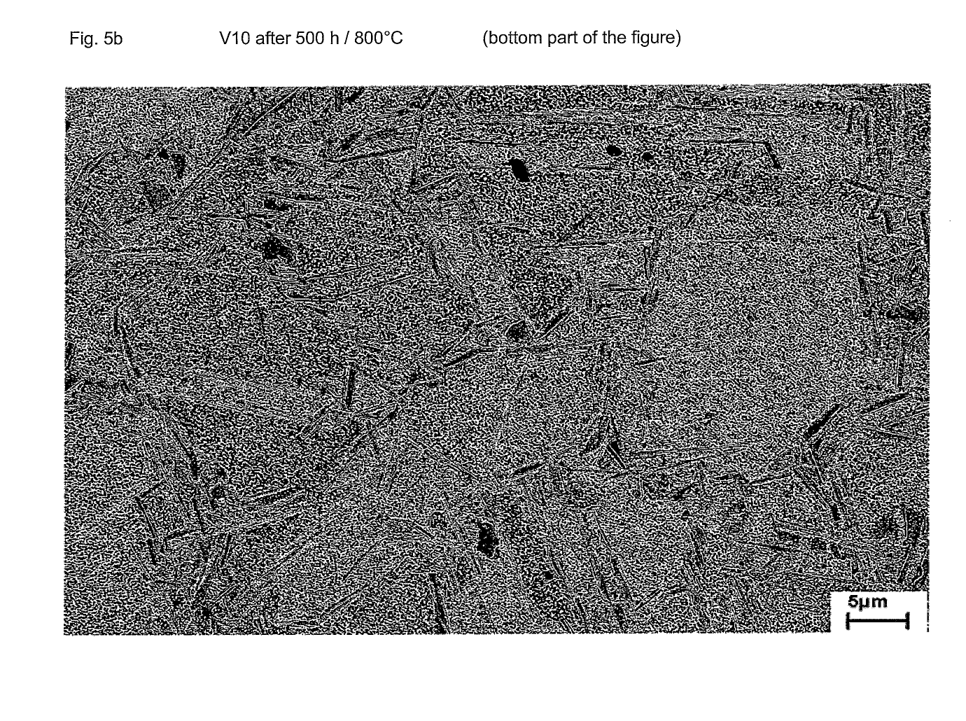

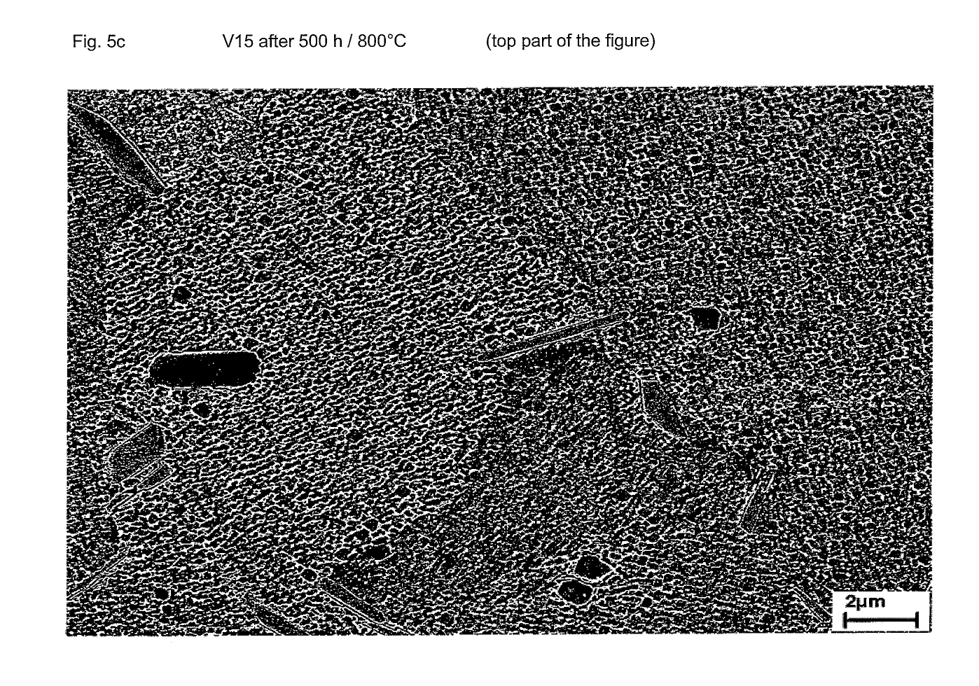

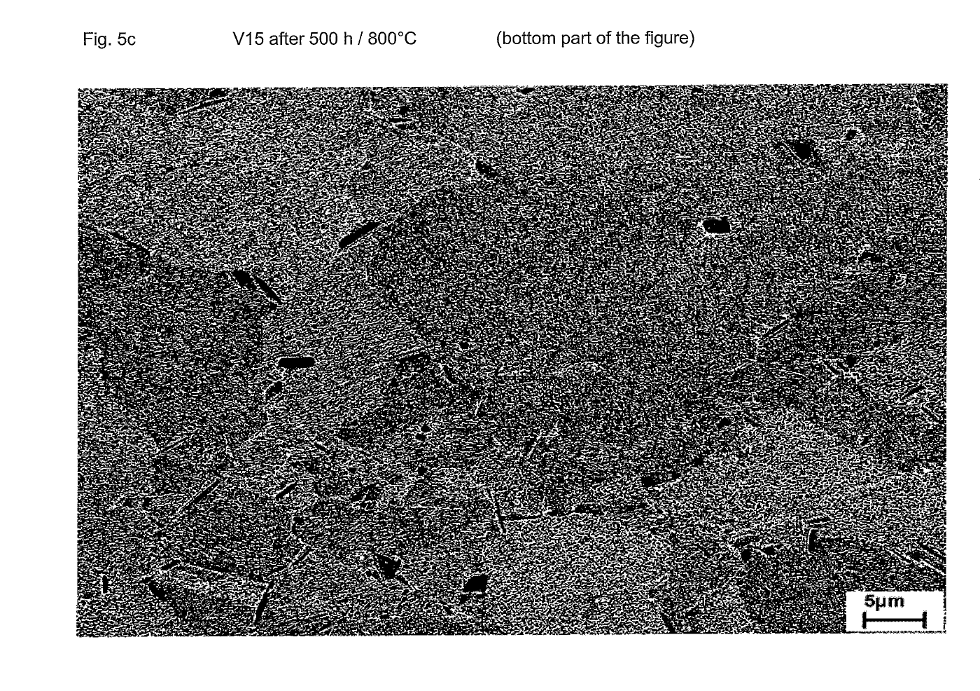

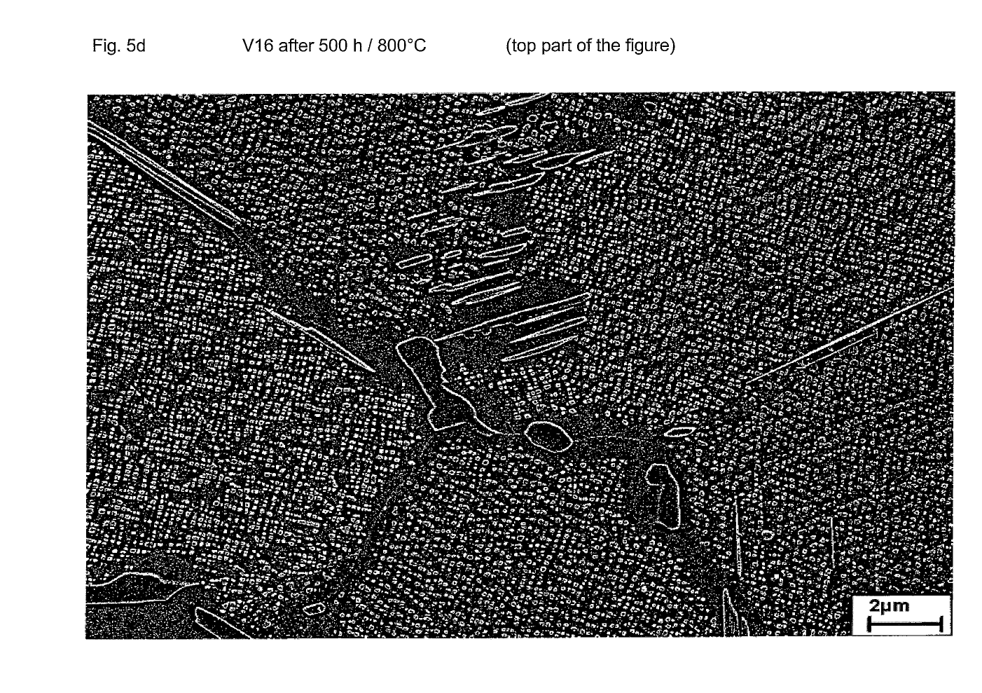

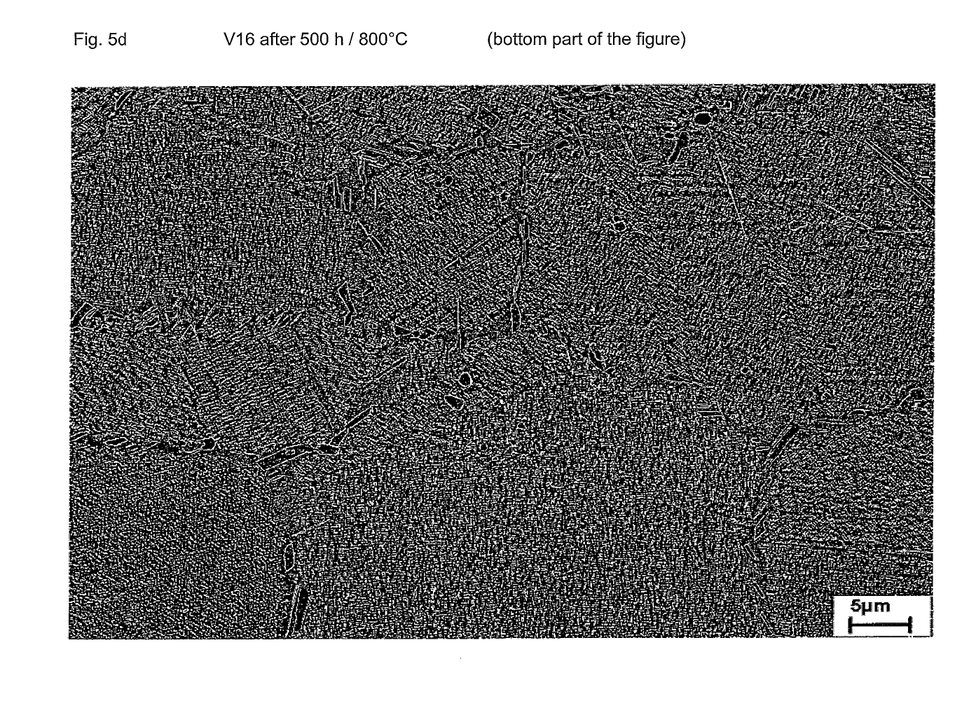

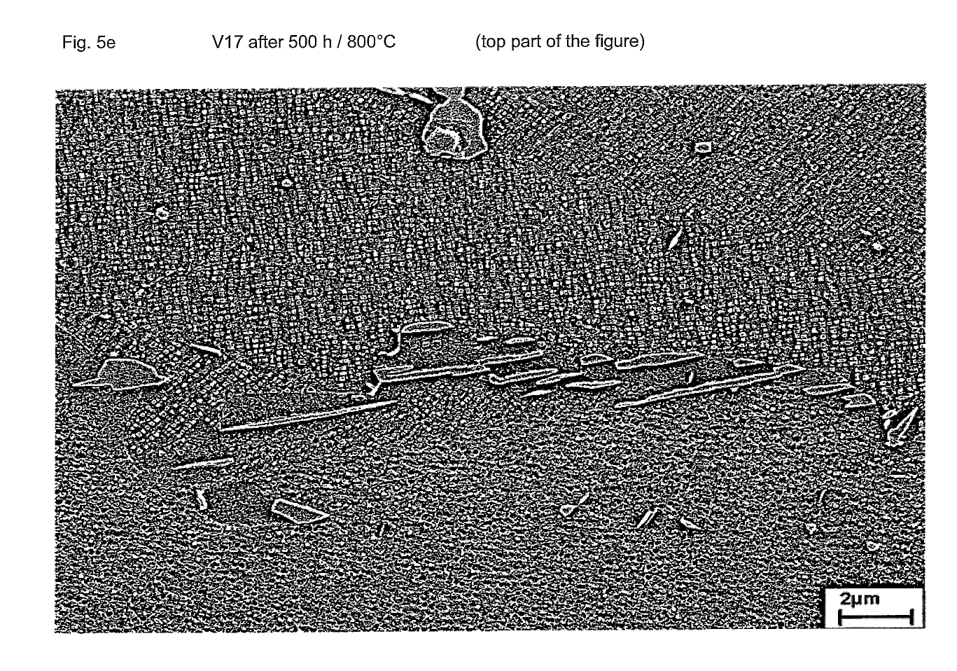

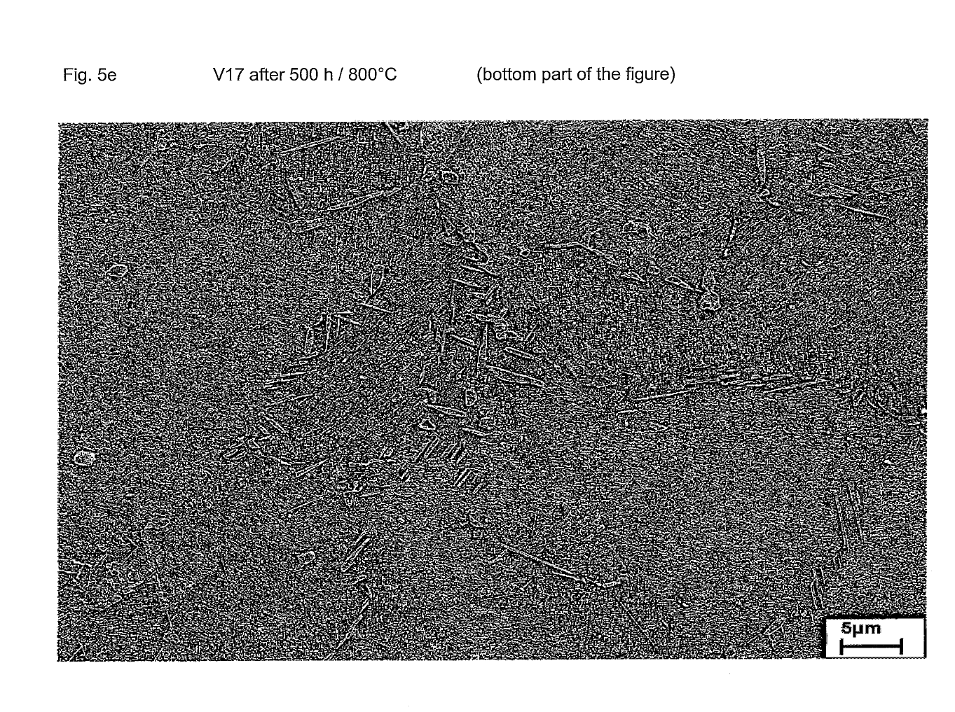

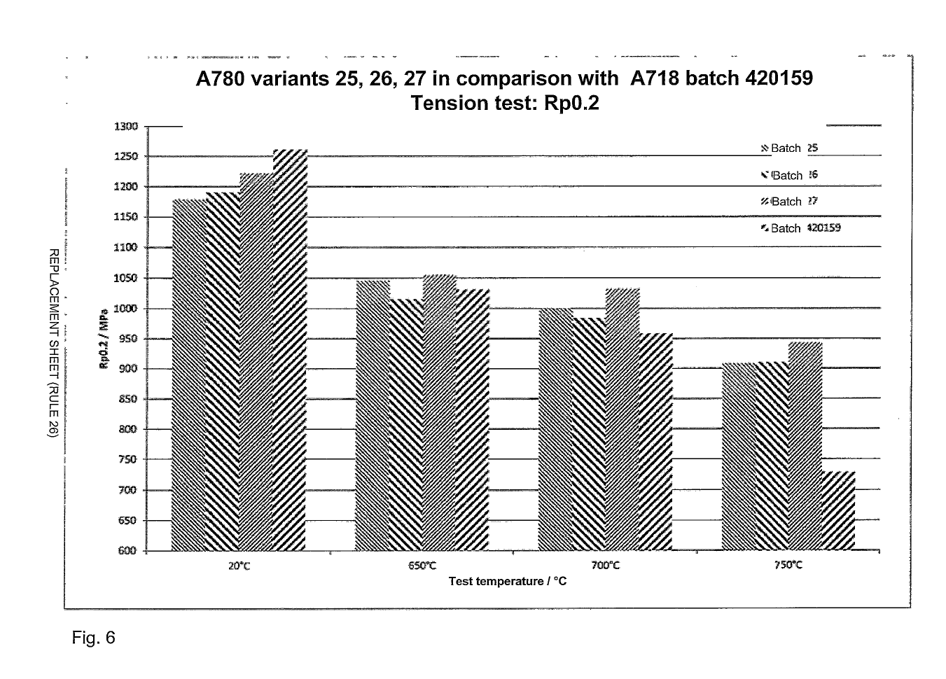

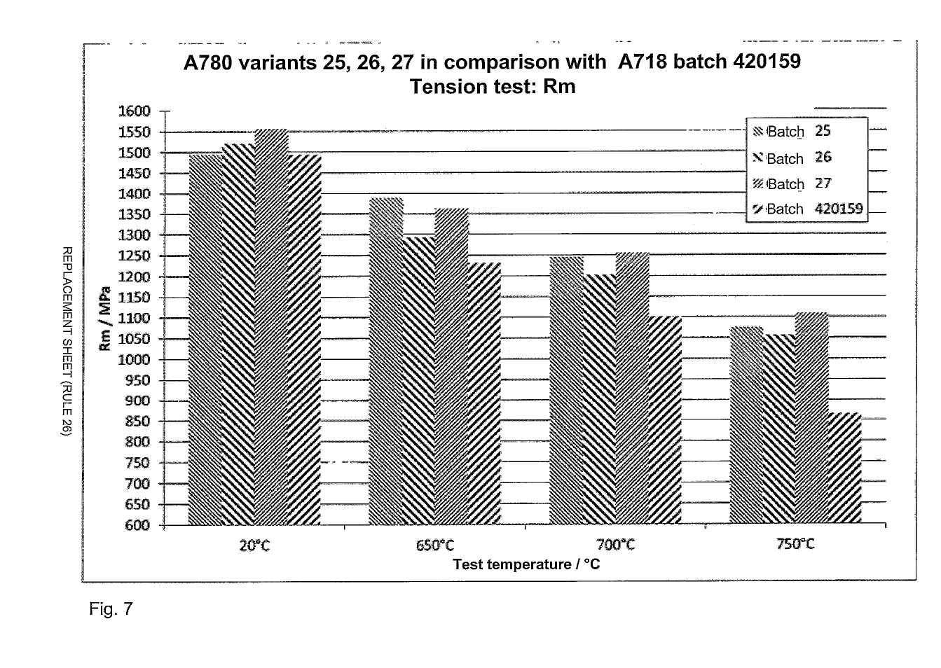

1-17. (canceled)

18: An Ni—Co alloy with 30 to 65 wt % Ni, >0 to max. 10 wt % Fe, >12 to <35 wt % Co, 13 to 23 wt % Cr, 1 to 6 wt % Mo, 4 to 6 wt % Nb+Ta, >0 to <3 wt % Al, >0 to <2 wt % Ti, >0 to max. 0.1 wt % C, >0 to max. 0.03 wt % P, >0 to max. 0.01 wt % Mg, >0 to max. 0.02 wt % B, >0 to max. 0.1 wt % Zr, if necessary containing as residual elements:
max. 0.5 wt % Cu
max. 0.015 wt % S
max. 1.0 wt % Mn
max. 1.0 wt % Si
max. 0.01 wt % Ca
max. 0.03 wt % N
max. 0.02 wt % O,
if necessary also containing:
up to 4 wt % V
up to 4 wt % W, wherein
the alloy satisfies the requirements and criteria listed below:
a) 900° C.≦γ′-solvus temperature≦1030° C. at 3 at %≦Al+Ti (at %)≦5.6 at % as well as 11.5 at %≦Co≦35 at %;
b) stable microstructure after 500 h of aging annealing at 800° C. and an Al/Ti ratio≧5 (on the basis of the contents in at %).

19. Alloy according to claim 18, which satisfies the requirement “945° C.≦γ′-solvus temperature≦1000° C.”.

20. Alloy according to claim 18, with ΔT (δ−γ′)≧80 K and Al+Ti≦4.7 at % as well as with Co contents ≧11.5 at % and ≦35 at %

21. Alloy according to claim 18, which has a temperature interval between δ-solvus and γ′-solvus temperatures equal to or greater than 140 K and a Co content ≧15 at % and ≦35 at %.

22. Alloy according to claim 18, with a Ti content of ≦0.8 at %.

23. Alloy according to claim 18, with a Ti content of ≦0.65 at %.

24. Alloy according to claim 18, with a content of 4.7≦Nb+Ta≦5.7 wt %.

25. Alloy according to claim 18, with contents of Ti, Al and Co in accordance with the following limit values:
0.05 at %≦Ti≦0.5 at %,
3.6 at %≦Al≦4.6 at %,
15 at %≦Co≦32 at %.

26. Alloy according to claim 18, wherein, if necessary, part of the elements Ni and/or Co may be substituted by the element Fe.

27. Alloy according to claim 18, wherein it is usable for the following semifinished forms: strip, sheet, wire, bar.

28. Use of the alloy according to claim 18 as components of an aircraft turbine, especially rotating turbine disks, as well as components of a stationary turbine.

29. Use of the alloy according to claim 18, in engine construction, in furnace construction, in boiler construction, in power-plant construction.

30. Use of the alloy according to claim 18, as a structural part in oil and gas extraction engineering.

31. Use of the alloy according to claim 18, as a structural part in stationary gas and steam turbines.

32. Use of the alloy according to claim 18, as a weld filler material.
